(19) United States
(12) Patent Application Publication
(10) Pub. No.: US 2026/0096693 A1
(43) Pub. Date: Apr. 9, 2026

(54) COOKING TOOLS

(71) Applicant: Michael Graves Design Group, Inc., Princeton, NJ (US)

(72) Inventors: Robert Beale Van Varick, Yardley, PA (US); Donald Samuel Strum, Princeton, NJ (US)

(21) Appl. No.: 19/351,109

(22) Filed: Oct. 6, 2025

Related U.S. Application Data
(60) Provisional application No. 63/704,339, filed on Oct. 7, 2024.

(51) Int. Cl. A47J 45/00; A47J 43/28

(52) U.S. Cl. CPC A47J 45/00; A47J 43/28

(57) ABSTRACT

Techniques, devices, components are provided for handling foodstuff objects that include a handle with a gripping surface having a first side and a second side, and a gripping member that extends away from either side. The gripping member is configured to interface with at least one digit of a user's hand or a support surface, and the gripping surface features a first aperture defined at least in part by the structure of the protrusion. The device also includes a first work device adapted to interact with foodstuff objects, and a frame extending within at least a portion of the handle and coupled to the first work device. The gripping member improves ergonomic comfort, control, and versatility during food preparation, while providing stable support and minimizing surface contact when the device is set down.

### REFERENCE TO RELATED APPLICATION

This application claims the benefit of and priority to U.S. Provisional Patent Application No. 63/704,339, filed on Oct. 7, 2024, and entitled COOKING TOOLS, the content of which is hereby incorporated by reference in its entirety.

### TECHNICAL FIELD

The field of the disclosure relates to cooking tools, and, more particularly, although not necessarily exclusively, to cooking tools with improved gripping features.

### BACKGROUND

Conventional cooking tools, such as spatulas, have long been essential implements in both domestic and professional kitchens for tasks such as stirring, flipping, and serving food. However, these conventional devices often present a range of ergonomic and hygienic challenges that impact both user experience and food safety. For example, conventional spatulas and other cooking tools typically include handles that can be difficult to securely hold, especially when hands are wet, greasy, or otherwise compromised during the cooking process. This difficulty is further exacerbated when the cooking tool must be manipulated at various angles to accommodate different cooking techniques or to access food in deep or awkwardly-shaped cookware, resulting in user discomfort and diminished control. Moreover, when cooking tools are used in conjunction with sauces or other liquid-based foods, users are frequently faced with the problem of where to place the utensil during brief pauses in use. A common practice of setting the cooking tool directly on countertops or stovetops. This not only creates unsightly messes and additional cleaning burdens but also increases a risk of cross-contamination between surfaces and food items, raising significant food safety concerns.

### SUMMARY

Embodiments covered by this patent are defined by the claims below, not this summary. This summary is a high-level overview of various embodiments and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

According to certain embodiments, a cooking tool includes a handle and a work device. The handle includes a gripping surface having a first side and a second side. The handle also includes a gripping member configured to extend from the gripping surface in a direction away from the first side or the second side. The gripping member includes a first aperture defined at least in part by a structure of the gripping member. The gripping member may interface with at least one digit of a hand of a user or a support surface. The work device may be configured to interact with a foodstuff object. Optionally, the device includes a frame. When included, the frame may extend from and/or within at least a portion of the handle and may be coupled to at least a portion of the first work device.

According to various embodiments, a cooking tool includes a work device, a handle, and a gripping post pivotably coupled to the handle. The gripping post includes a post body and a flange end opposite from an end of the gripping post coupled to the handle.

According to some embodiments, a cooking tool includes a work device, a handle with an upper surface and a lower surface, and a loop projecting outwards from the lower surface.

According to certain embodiments, cooking tongs include a pair of arms pivotably connected in a first direction. The cooking tongs further include a locking lever for controlling positioning and/or an angle between the arms. In some embodiments, the locking lever is movable in side-to-side direction, optionally in a second direction perpendicular to first. The locking lever is movable between at least three positions, the at least three positions including a first position in which the arms are closed and/or relative movement between the arms is prevented, a second position in which the arms are movable in a first range of movement, and a third position in which the arms are movable in a second range of movement greater than the first range of movement.

Various implementations described herein may include additional systems, methods, features, and advantages, which cannot necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The specification makes reference to the following appended figures, in which use of like reference numerals in different figures is intended to illustrate like or analogous components.

FIG. 1A is a simplified diagram of an example cooking tool with a deployed gripping member, according to various embodiments.

FIG. 1B is a simplified diagram of an example cooking tool with a stowed gripping member, according to various embodiments.

FIG. 2 is a simplified exploded diagram of a portion of an example cooking tool with a gripping member, according to various embodiments.

FIG. 3A is a simplified diagram of an example gripping member with a surface, according to various embodiments.

FIG. 3B is a simplified diagram of an example gripping member with a surface, according to various embodiments.

FIG. 4A is a simplified diagram of an example cooking tool with a forward deployed gripping member, according to various embodiments.

FIG. 4B is a simplified diagram of an example cooking tool with a rear-ward deployed gripping member, according to various embodiments.

FIG. 5 is a simplified diagram of various cooking tools with various positions of a gripping member, according to various embodiments.

FIG. 6A is a simplified diagram of an example cooking tool with rear positioned gripping member in a deployed configuration, according to various embodiments.

FIG. 6B is a simplified diagram of an example cooking tool with rear positioned gripping member in a stowed configuration, according to various embodiments.

FIG. 7 is a simplified diagram of an example hand gripping position for a cooking tool with a gripping member, according to various embodiments.

FIG. 8A is a simplified diagram of an example cooking tool with a forward deployed gripping member, according to various embodiments.

FIG. 8B is a simplified diagram of an example cooking tool with a rearward deployed gripping member, according to various embodiments.

FIG. 9A is a simplified diagram of an example cooking tool in a surface supported configuration, according to various embodiments.

FIG. 9B is a simplified diagram of an example cooking tool with a stowed gripping member, according to various embodiments.

FIG. 10A is a simplified diagram of an example cooking tool with a forward deployed gripping member, according to various embodiments.

FIG. 10B is a simplified diagram of an example cooking tool with a rearward deployed gripping member, according to various embodiments.

FIG. 11A is a simplified diagram of an example cooking tool in a surface supported configuration, according to various embodiments.

FIG. 11B is a simplified diagram of an example cooking tool with a stowed gripping member, according to various embodiments.

FIG. 12A is a simplified diagram of an example cooking tool with a forward deployed gripping member, according to various embodiments.

FIG. 12B is a simplified diagram of an example cooking tool with a rearward deployed gripping member, according to various embodiments.

FIG. 13A is a simplified diagram of an example cooking tool in a surface supported configuration, according to various embodiments.

FIG. 13B is a simplified diagram of an example cooking tool with a stowed gripping member, according to various embodiments.

FIG. 14A is a simplified diagram of an example cooking tool with a forward deployed gripping member, according to various embodiments.

FIG. 14B is a simplified diagram of an example cooking tool with a rearward deployed gripping member, according to various embodiments.

FIG. 15A is a simplified diagram of an example cooking tool in a surface supported configuration, according to various embodiments.

FIG. 15B is a simplified diagram of an example cooking tool with a stowed gripping member, according to various embodiments.

FIG. 16A is a simplified diagram of an example cooking tool with a stowed gripping member, according to various embodiments.

FIG. 16B is a simplified diagram of an example cooking tool in a surface supported configuration, according to various embodiments.

FIGS. 17A-H are simplified diagrams of example cooking tools with gripping members, according to various embodiments.

FIG. 18 is a simplified diagram of example cooking tools with gripping members, according to various embodiments.

FIG. 19 is a simplified diagram of example cooking tools in a stacked configuration with gripping members in complementary positions, according to various embodiments.

FIG. 20A is a simplified diagram of example cooking tools with gripping members with work devices on two ends in a stacked configuration, according to various embodiments.

FIGS. 20B-C are simplified diagrams of example cooking tools with gripping members with work devices on two ends, according to various embodiments.

FIG. 20D-E are simplified diagrams of example cooking tools with gripping members with work devices on two ends, according to various embodiments.

FIG. 21A is a simplified diagram of example cooking tools with gripping members with work devices on two ends, according to various embodiments.

FIG. 21B is a simplified diagram of example cooking tools with gripping members with work devices on two ends in a stacked configuration, according to various embodiments

FIG. 22 is a simplified diagram of example cooking tool with a gripping member, according to various embodiments.

In the drawings, like reference numerals refer to like parts throughout the various views unless otherwise specified. Not all instances of an element are necessarily labeled to reduce clutter in the drawings where appropriate. The drawings are not necessarily to scale, emphasis instead being placed upon illustrating the principles being described.

### DETAILED DESCRIPTION

The subject matter of embodiments of the present disclosure is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

As mentioned above, conventional cooking utensils, such as spatulas, are indispensable in both home and professional kitchens for a variety of culinary tasks, including stirring, flipping, and serving food. Despite their ubiquity and utility, these traditional tools often suffer from several significant shortcomings. Users frequently encounter difficulties in maintaining a secure and comfortable grip, particularly when their hands are wet, greasy, or otherwise compromised during food preparation. Additionally, existing cooking tool designs generally do not provide a suitable solution for temporarily setting down the utensil during cooking, especially when handling sauces or other liquids. This often results in the cooking tool (or work device) being placed directly on countertops or stove surfaces, leading to messy workspaces, increased cleaning burdens, and a heightened risk of cross-contamination between surfaces and food items.

To address these deficiencies, cooking tools according to embodiments herein enhance user comfort and control and provide an effective mechanism for maintaining kitchen hygiene. In various embodiments, the cooking tools described herein generally include a and a work device. The handle includes a gripping member which may extend from the gripping surface in a direction away from the first side or the second side of the handle. The gripping member includes a first aperture defined at least in part by a structure of the gripping member. The gripping member may interface with at least one digit of a hand of a user or a support surface. The work device may be configured to interact with a foodstuff object

In certain embodiments, the gripping member is a stowable and deployable grip and support component. In such embodiments, the support component may at least partially resolve ergonomic and sanitary limitations of conventional cooking tools devices. The support component can be easily deployed with one or two hands while in use to elevate a work device of the cooking tool when not in active use to preventing direct contact with undesirable surfaces to minimize food and surface contamination. Furthermore, the support component can be retracted and stowed when not needed to ensure that the tool remains unobtrusive during active cooking.

The technical improvements embodied in this disclosure provide a multifaceted improvement over conventional cooking utensils. The deployable support component acts as a sanitary rest, keeping the utensil elevated and surfaces clean, but also serves as an auxiliary grip or brace to give the user enhanced control and stability when manipulating the tool at various angles and positions. This added versatility is particularly beneficial when cooking with deep or irregularly shaped cookware, as it allows for more precise and comfortable handling. The stowable nature of the support ensures that it does not interfere with everyday use or storage, preserving the ergonomic profile of the utensil.

In addition to the stowable and deployable support component described above, various embodiments of the present disclosure are also directed towards a gripping member which includes a non-stowable, fixed loop support component that performs similar functions. This non-stowable support is formed and/or securely attached to the body of the cooking tool (e.g., tongs, spoons, cups, etc.), providing a constant and reliable means for manipulating the work device of the utensil above kitchen surfaces during periods of non-use. Furthermore, the loop is ergonomically designed to act as an auxiliary grip or brace, giving users improved leverage and stability when manipulating the cooking tool at various orientations and angles. This configuration allows for ease of use in a range of cooking scenarios, particularly when handling heavy or unwieldy foods or when working with deep cookware. The non-stowable support loop thus offers a straightforward solution to the ergonomic and hygiene deficiencies of conventional cooking utensils to ensure that the cooking tool remains continuously ready to promote a clean and controlled cooking environment.

Various other benefits and advantages may be realized with the systems and methods provided herein, and the aforementioned advantages should not be considered limiting.

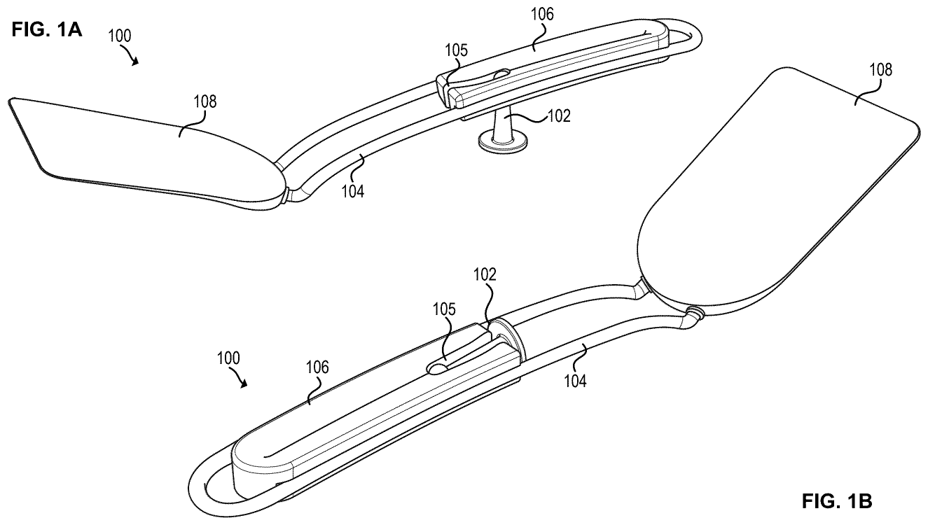

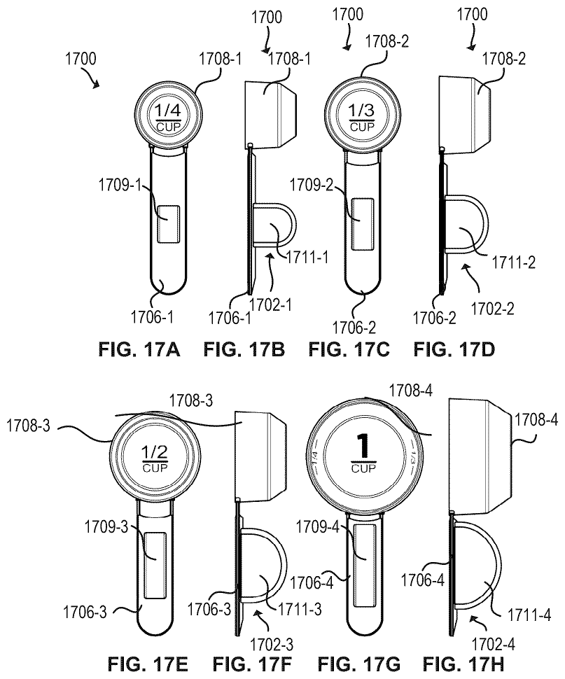

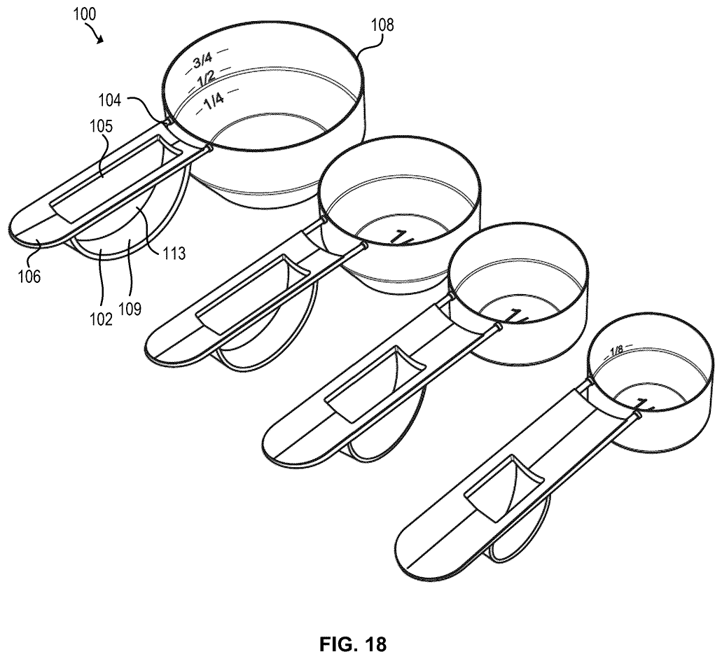

FIGS. 1A-22 illustrate a cooking tool 100 according to embodiments. The cooking tool generally includes a gripping member 102, a handle 106, and at least one work device 108 connected to the handle 106 (directly or indirectly, such as utilizing optional frame 104). Optionally, the cooking tool 100 includes a frame 104, although in other embodiments the cooking tool 100 need not include the frame 104. As described in detail below, in certain embodiments the gripping member 102 may be movable relative to the handle 106 (see, e.g., FIGS. 1A-16) or may be fixed or non-movable (see, e.g., FIGS. 17-22).

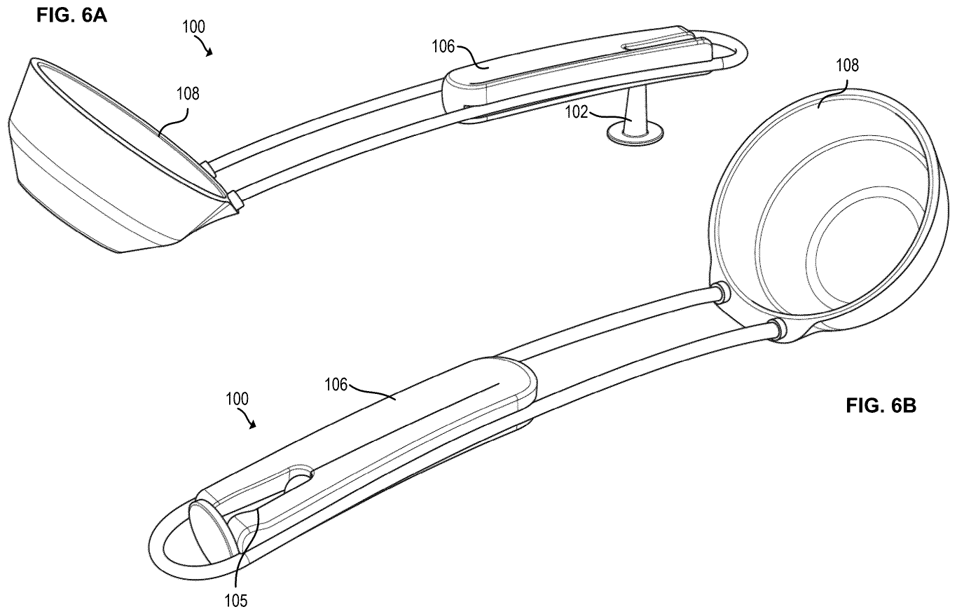

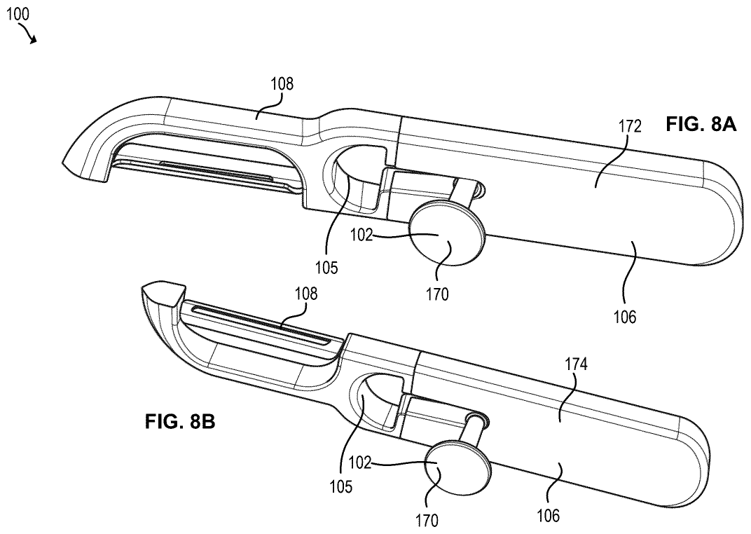

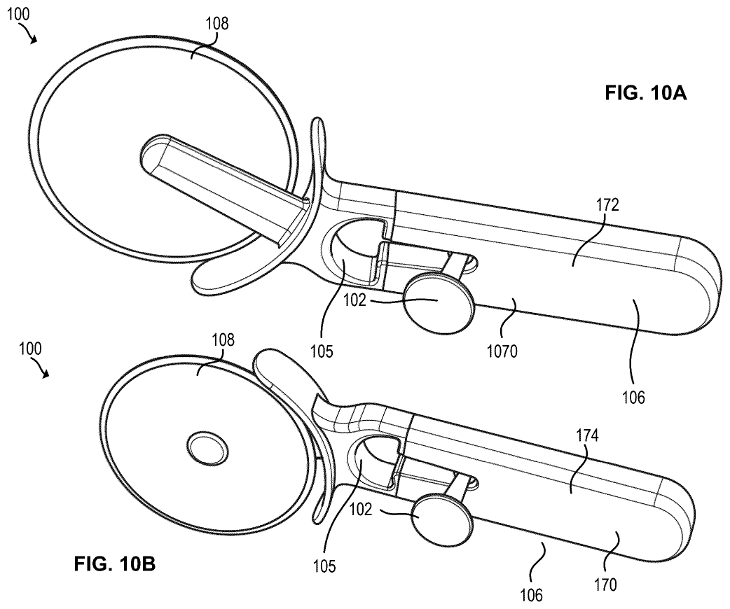

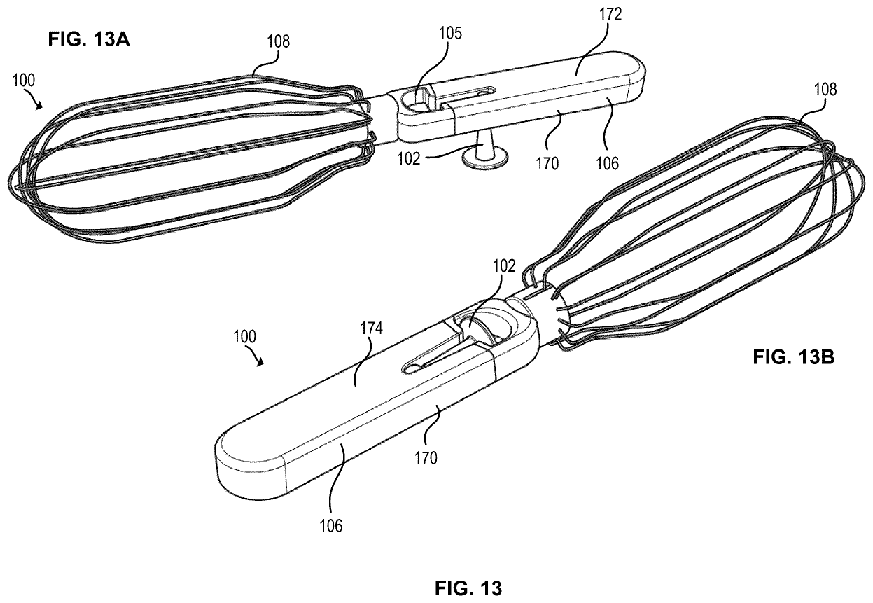

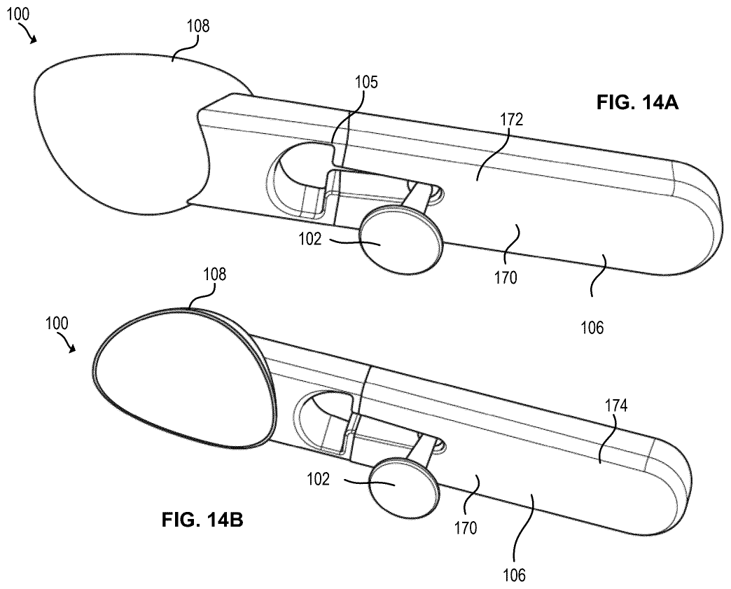

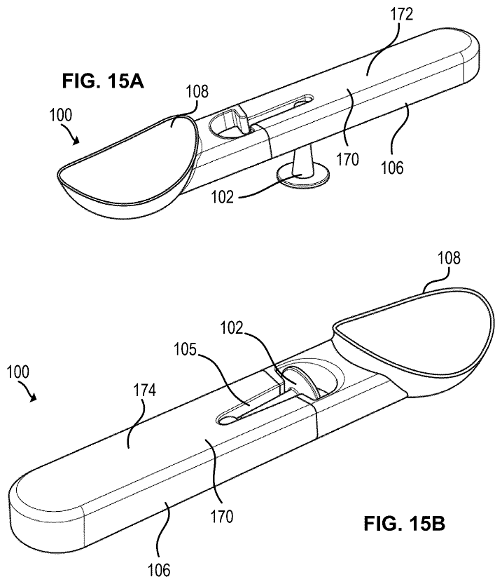

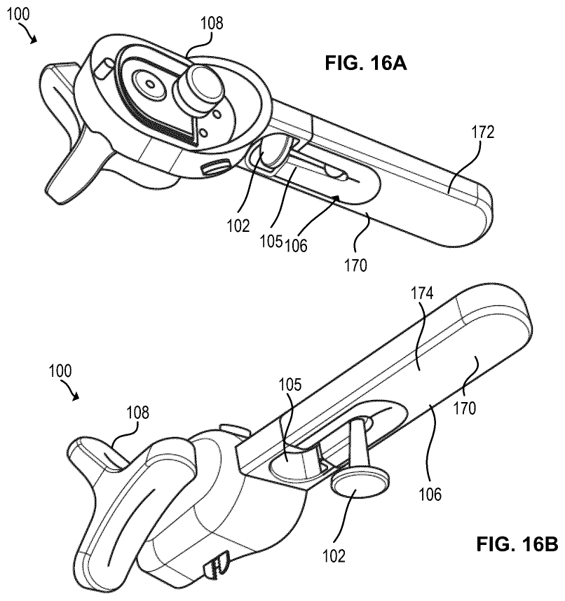

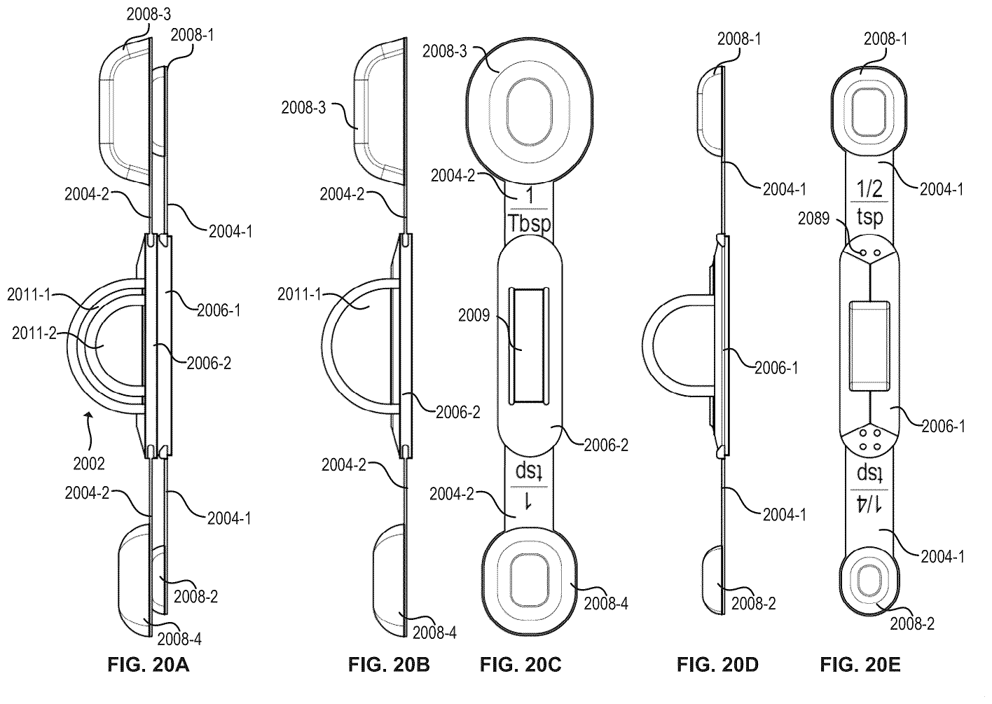

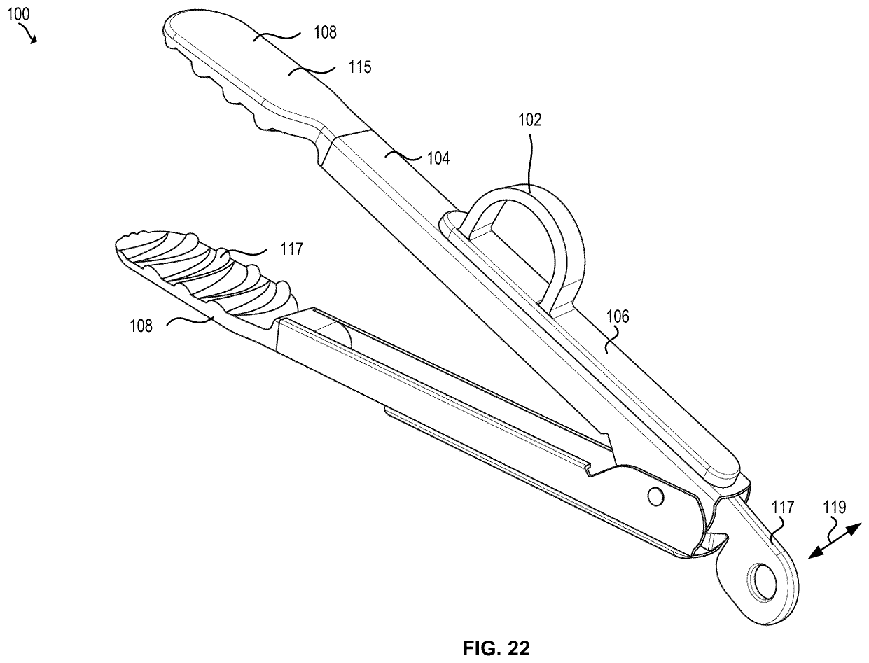

The work device 108 may be any suitable object, tool, or surface that is capable of handling, interacting, and/or manipulating foodstuffs (e.g., meats, sauces, vegetables, starches, and suitable equivalents) in a desired manner. Moreover, in various embodiments, a cooking tool 100 may include one work device 108 or a plurality of work devices 108. When a plurality of work devices 108 are connected to the handle 106, they may be a same type and/or size of work device 108 or different types and/or sizes of work devices 108 as desired. As used herein, the term “work device” is intended to broadly refer to the portion of the cooking tool 100 that interacts directly with foodstuffs during use, sometimes known as a “business end” of the cooking tool, such as the blade, head, or surface used for stirring, flipping, serving, or otherwise handling foodstuffs. This terminology is not intended to be limiting or restrictive in any way. Accordingly, the term “work device” is to be interpreted expansively to encompass any configuration or construction wherein a portion of the device is adapted to contact and manipulate foodstuffs, regardless of its specific shape, structure, or method of integration within the cooking tool 100. As non-limiting examples, the work device 108 may be a spatula (see, e.g., FIGS. 1A-B and 4A-B), a pizza cutter (see, e.g., FIGS. 10A-B and 11A-B), a can opener (see, e.g., FIGS. 16A-B), tongs (see, e.g., FIG. 22), a measuring cup (see, e.g., FIGS. 17-19), a measuring spoon (see, e.g., FIGS. 20A-C and 21A-B), a whisk (see, e.g., FIGS. 13A-B, a ladle (see, e.g., FIGS. 6A-B), a slotted spoon, a serving spoon, a fork, a knife, a peeler (see, e.g., FIGS. 8A-B and 9A-B), a grater, a zester, a bottle opener, a garlic press, a potato masher, a strainer, a sieve, a pastry brush, a scoop (see, e.g., FIGS. 14A-B), a melon baller (see, e.g., FIGS. 15A-B), a meat tenderizer, a juicer, a pestle, a thermometer, a cheese slicer, a butter curler, an egg separator, an apple corer, a cherry pitter, a nutcracker, a fish scaler, a bread knife, a pizza peel, a cake server, a pie server, a cookie cutter, a pasta fork, a spaghetti server, a turner, a rice paddle, a dough hook, shears, a crinkle cutter, combinations thereof, and/or other work devices as desired.

The work device 108 may be connected directly or indirectly to the handle 106 using various techniques or mechanisms as desired. In some embodiments, the work device 108 may be formed as a discrete component attached to the handle 106 and/or the frame 104, while in other embodiments, it may be integrally formed with or structurally continuous with the frame 104 and/or handle 106. As non-limiting examples, in some embodiments, the work device 108 may be connected to the handle 106 (see, e.g., FIGS. 8A-16B). Additionally, or alternatively, a frame 104 may connect the handle 106 and the work device 108 (see, e.g., FIGS. 1A-B, 4A-B, and 5-7).

In embodiments with the optional frame 104, the frame 104 may provide support, rigidity, and/or flexibility to the work device 108. The frame 104 may be made from any suitable material that is appropriate for use with foodstuffs and capable of safely contacting foodstuffs, including, without limitation, metal (e.g., stainless steel, aluminum, and suitable equivalents), an alloy (e.g., stainless steel alloy, anodized aluminum alloy, and suitable equivalents), a plastic (e.g., food-grade polypropylene, polycarbonate, and suitable equivalents), a ceramic (e.g., glazed stoneware, porcelain, and suitable equivalents), a polymer (e.g., silicone, polytetrafluoroethylene (PTFE), and suitable equivalents), or any combination thereof. Each of these materials may be selected based at least in part on a desired durability, a desired ease of cleaning, a desired resistance to heat, and/or ability to withstand repeated exposure to various food substances and cleaning agents (e.g., dishwasher safe). As non-limiting examples, the frame 104 may be stainless steel, silicone, combinations thereof, and/or other materials as desired. Combinations of these materials may also be employed to optimize structural integrity, ergonomics, and food safety, such as a spatula with a stainless-steel frame 104 for strength and a silicone exterior for comfortable gripping and non-stick performance.

The frame 104 may be configured in any suitable shape or form to meet the functional and aesthetics desired of the cooking tool 100. As a non-limiting example, the frame 104 may be substantially planar (e.g., a flat metal or polymer strip), may form a continuous loop (e.g., an elongated oval or circular band providing structural integrity), or may be unitary (e.g., integrally formed as a single piece by molding, casting, or forging). In addition, or alternatively, the frame 104 may be composed of multiple pieces that are joined together by any appropriate means, (e.g., welding, adhesive bonding, fasteners, or interlocking features) allowing for modularity or ease of assembly. The choice of frame 104 configuration may depend on considerations such as strength, weight, ease of manufacture, ergonomic comfort, and intended use. Accordingly, the frame 104 is not limited to any particular geometric configuration or construction method, but instead may be shaped, sized, and assembled in any manner suitable for supporting the handle 106, work device 108, or other components of the cooking tool 100, as desired for a given application.

The handle 106 may be supported at least in part by the frame 104 and/or the handle 106 may directly engage and/or otherwise be connected to the work device 108 as desired. The handle 106 may include a gripping surface 107 (e.g., the portion that a user's hand wraps around, engages, and/or supports). In various embodiments, the handle 106 may be selected from any suitable material that is safe for use in culinary contexts and capable of withstanding an environment of repeated usage, including, without limitation, a metal (e.g., stainless steel, aluminum, and suitable equivalents), an alloy (e.g., titanium alloy, anodized aluminum alloy, and suitable equivalents), a plastic (e.g., food-grade polypropylene, acrylonitrile butadiene styrene (ABS), and suitable equivalents), a ceramic (e.g., glazed ceramic, porcelain, and suitable equivalents), a polymer (e.g., silicone, PTFE, and suitable equivalents), wood (e.g., maple, beechwood, bamboo, and suitable equivalents), or any combination thereof. Each of these materials may be selected for desired attributes such as heat resistance, ergonomic comfort (e.g., left hand, right hand, ambidextrous, finger depressions, palm depressions, etc.), ease of cleaning, resistance to food stains and odors, and/or durability under washing and handling. For example, the handle 106 may be formed from silicone (e.g., high-temperature silicone rubber) that offers a soft, non-slip grip and remains cool to the touch even when exposed to high temperatures, while if the handle 106 is constructed from wood (e.g., bamboo), the wood provides a natural, warm feel and aesthetic appeal, and is less likely to become slippery when wet. Metal handles (e.g., brushed stainless steel) may be used to aid in strength and longevity, while plastic handles (e.g., food-grade polypropylene) offer lightweight construction and can be molded into ergonomic shapes for user comfort.

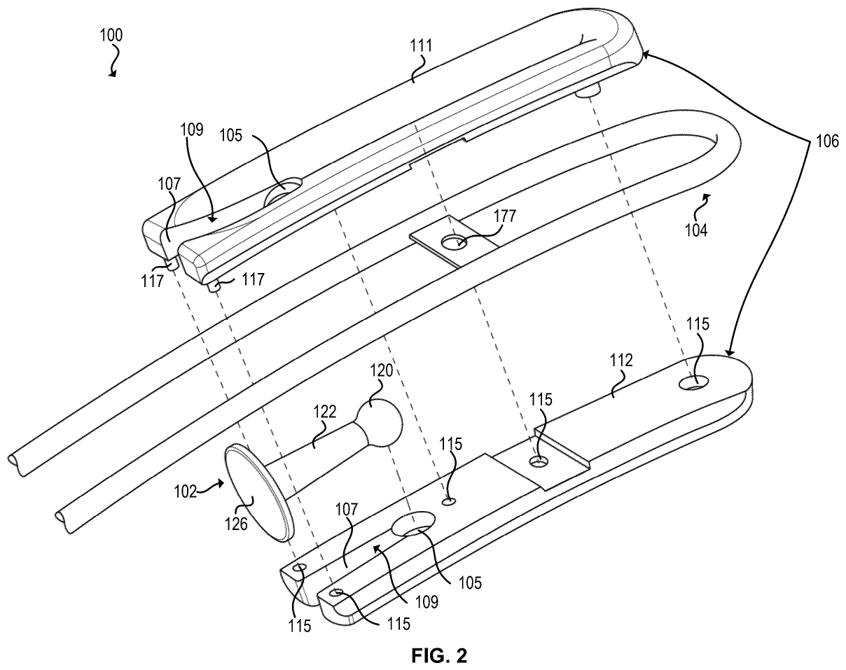

The handle 106 may have various shapes or profiles as desired. As non-limiting examples, the handle 106 may be substantially linear (e.g., a straight rod or bar), contoured or ergonomically shaped (e.g., with curves, bulges, or recesses to fit the hand), or may feature a looped or ring-shaped configuration (e.g., a circular or oval grip for alternative holding positions). In some embodiments, the handle 106 may be integrally formed as a unitary piece with the frame 104 or work device 108 (e.g., by molding or forging a single piece of material). In addition, or alternatively, the handle 106 may be constructed from multiple pieces that are assembled together using any suitable joining method (discussed in more detail with respect to FIG. 2) (e.g., adhesive bonding, mechanical fasteners, overmolding, or interlocking structures) permitting the incorporation of different materials or modular features (e.g., grips).

Optionally, the handle 106 may be provided with features such as textured surfaces, non-slip coatings, and/or thermal insulation layers to further enhance ergonomic comfort, grip, and/or heat resistance. Accordingly, the handle 106 is not limited to any particular geometric configuration, method of manufacture, or material composition, but may be shaped, dimensioned, and assembled in any manner appropriate for supporting the user's hand and facilitating the operation of the cooking tool 100, as desired for a given application.

The gripping member 102 is provided with the cooking tool 100 for providing improved engagement and/or handling by a user, and/or for providing at least partial support of the cooking tool 100 on a surface. The gripping member 102 may be provided on various components of the cooking tool 100 as desired. As non-limiting examples, FIGS. 1A-22 illustrate the gripping member 102 on the handle 106 of the cooking tool 100. In other embodiments, the gripping member 102 may be provided on the optional frame 104, work device 108, and/or other feature as desired.

In some embodiments, and as illustrated in FIGS. 1A-16B, the gripping member 102 is connected to the cooking tool 100 such that the gripping member 102 is movable relative to the cooking tool 100 between a stowed configuration and a deployed configuration, and any position in between. In certain embodiments, in addition to being movable between a stowed configuration and a deployed configuration (e.g., in a first direction), the movable gripping member 102 may further be movable in a side-to-side direction, or a second direction different from the first direction, when the movable gripping member 102 is not stowed.

In such embodiments, the gripping member 102 may be pivotable, rotatable, and/or otherwise movable as desired, and as such may be connected to the cooking tool 100 using various types of connections as desired. As non-limiting examples, the gripping member 102 may include a ball connector (e.g., a ball-and-socket joint that enables single or multi-axial rotation), a hinge connector (e.g., a single-axis hinge, piano hinge, or barrel hinge), a pin connector (e.g., a pivot pin received within aligned apertures), a clevis connector (e.g., a U-shaped clevis with a transverse pin permitting swinging motion), a universal joint (e.g., a cross-and-bearing assembly allowing compound angular movement), a rotary coupler (e.g., a keyed or splined shaft enabling controlled rotation), a cam connector (e.g., a cam and follower for guided pivoting), a living hinge (e.g., a flexible polymer strip integrally formed to permit bending), a swivel connector (e.g., a rotating collar or disk), a pivoting latch (e.g., a latch arm that rotates into or out of engagement), spring-loaded connectors (e.g., components biased into a default position but capable of pivoting when actuated), detent-based connectors (e.g., ball detents, spring detents, or ratchet mechanisms that permit incremental pivoting), articulated linkages (e.g., multi-jointed arms or levers), or any combination thereof.

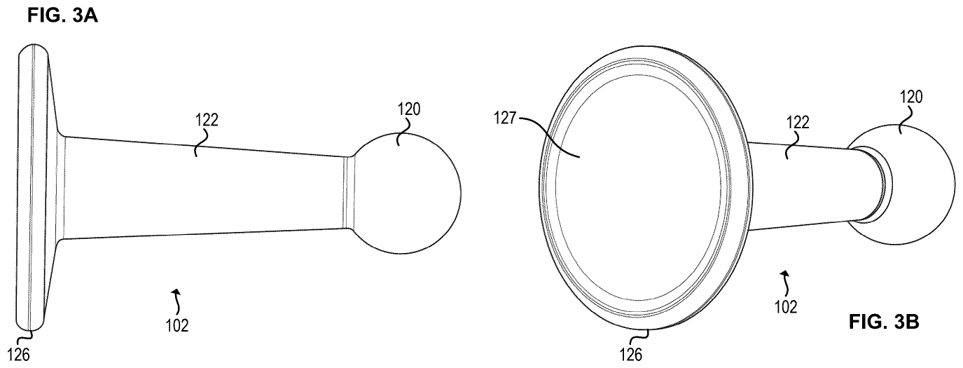

In embodiments with the movable gripping member 102, and as illustrated in FIGS. 3A-B for example, the gripping member 102 generally includes a first end 120 which is coupled to the cooking tool 100 (e.g., the handle 106) and a second end 126 opposite the first end 120 and which is a “free” end (e.g., not connected to the cooking tool 100. In these embodiments, the second end 126 may be moved relative to the first end 120 coupled with the cooking tool 100. As illustrated in FIG. 3B, the second end 126 includes a surface 127. In various embodiments, a user may cause movement of the gripping member 102 by engaging the surface 127 and/or the second end 126 generally.

FIGS. 1A-B illustrate a non-limiting example of the gripping member 102 in stowed and deployed configurations. In the deployed configuration (see, e.g., FIG. 1A), the movable gripping member 102 may be pivoted or rotated relative to the handle 106 such that the gripping member 102 generally extends away from or outwards from the handle 106. In other words, in the deployed configuration, the second end 126 of the gripping member 102 is spaced apart from the handle 106.

The gripping member 102 may be configured to pivot freely about one or more degrees of freedom relative to the handle 106 and be deployed to provide support to the cooking tool 100 when handled. For example, the gripping member 102 may be deployed from 0 degrees to 180 degrees relative to the stowed configuration, where the stowed configuration is 0 degrees. While not depicted, the gripping member 102 optionally may be able to have full 360 degree rotation about the handle 106 through a second aperture that is placed as a mirror opposite towards the other end of the cooking tool 100.

In the stowed configuration (see, e.g., FIG. 1B), the second end 126 may be positioned closer to the handle 106 than in the deployed configuration and/or the gripping member 102 generally does not extend outwards from the handle 106 compared to the deployed configuration. In some embodiments, in the stowed configuration, the gripping member 106 is positioned within an aperture 105 of the cooking tool 100. In these embodiments, the aperture 105 may be defined by various portions of the cooking tool 100 as desired, such as but not limited to the handle 106 (see, e.g., FIGS. 1A-B), the frame 104, and/or the work device 108 (see, e.g., FIGS. 8A-B). In certain embodiments, the gripping member 102 may be shaped and dimensioned to fit snugly within the aperture 105, such that the gripping member 102 may be unobtrusive and does not interfere with a normal operation or storage of the cooking tool 100 when not in use and/or in the stowed configuration.

Optionally, to facilitate secure retention of the gripping member 102 in the stowed configuration, any suitable locking or securing mechanism may be employed, including, without limitation, snap-fit features (e.g., resilient tabs or projections that engage corresponding detents or grooves), couplers (e.g., friction-fit sleeves, hinge couplings, or latch assemblies), mechanical connectors (e.g., spring-loaded pins, magnetic catches, or interlocking rails), or other engagement structures. When included, such mechanisms may be configured to provide tactile feedback, audible indication (e.g., a “click” sound), or visual confirmation that the grip is properly locked in place for both safety and ease of use. The locking or securing mechanism may be designed to resist inadvertent release or disengagement to prevent accidental deployment during normal handling or storage. The specific configuration, placement, and operation of the locking or securing mechanism are not limited to any particular structure or method but may be adapted as desired for a given application or manufacturing process, without departing from the cooking tools disclosed herein. In other embodiments, such features need not be included.

In embodiments with the movable gripping member 102, the gripping member 102 may have various shapes or profiles as desired, and the particular movable gripping member 102 illustrated should not be considered limiting. As non-limiting examples, and as best illustrated in FIGS. 3A-B, the movable gripping member 102 is illustrated as a gripping post with a body 122 connecting the first end 120 (or “head end”) with the second end 124 (or “flange end”), and the shape, dimension, and profile of the second end 124 is different from that of the first end 120. In other embodiments, the movable gripping member 120 may have various other shapes, profiles, and dimensions as desired.

The movable gripping member 102 may have various constructions as desired. In some embodiments, the movable gripping member 102 is a unitary construction made from a same material. In other embodiments, the movable gripping member 102 may be a composite construction with two or more different materials. As non-limiting examples, the gripping member 102 may be made from any material appropriate for use in kitchen environments, including, without limitation, a metal (e.g., stainless steel, aluminum), an alloy (e.g., brass, anodized aluminum alloy), a plastic (e.g., food-grade polypropylene, nylon), a polymer (e.g., polycarbonate, reinforced fiberglass), a ceramic (e.g., glazed porcelain), a composite (e.g., carbon fiber-reinforced polymer), or any combination thereof.

The movable gripping member 102 may be connected to various portions of the cooking tool 100 as desired. As non-limiting examples, FIGS. 1A-B illustrate the gripping member 102 connected to an end of the handle 106 proximate to the work device 108 while FIGS. 6A-B illustrate the gripping member 102 connected to an end of the handle 106 opposite from the work device 108. In the embodiment illustrated in FIGS. 1A-16B, the gripping member 102 is pivotably connected to the handle 106. The gripping member 102 may be pivotably connected to the handle 106 using various techniques or mechanisms as desired. As a non-limiting example, and as illustrated in FIG. 2, the handle 106 optionally may include two or more components that fit together (along the dashed lines) by way of one or more handle connectors (not depicted, screws, bolts, etc.) that fit into one or more connector apertures 115 to join the handle 106, by way of side 111 and side 112, together along the frame 104 and provide support to the handle 106 on the frame 104. The handle 206 may include the aperture 105 that receives the gripping member 102. In addition, or alternatively, the frame 104 optionally may include a frame aperture 177 configured to receive either a portion of the handle 106 or a connector (e.g., bolt, screw, etc.). In various embodiments, the handle includes one or more fittings 117 configured to fit within connector apertures 115. The position, size, shape, type of the fittings 117, connector apertures 115 are not intended to be limiting and any suitable position, size, shape, type is anticipated within the scope of this disclosure. The particular handle 106 illustrated in FIG. 2 should not be considered limiting, and other handle constructions and/or connections with the gripping member 102 may be utilized as desired.

The choice of connector type, material, and actuation method may be determined based on a desired range of motion, mechanical strength, ease of use, and aesthetic considerations relevant to the cooking tool's intended application. The body connector 320 may be made of any suitable material appropriate for use in foodstuff environments, including, without limitation, a metal (e.g., stainless steel, aluminum), an alloy (e.g., brass, anodized aluminum alloy), a plastic (e.g., food-grade polypropylene, nylon), a polymer (e.g., polycarbonate, reinforced fiberglass), a ceramic (e.g., glazed porcelain), a composite (e.g., carbon fiber-reinforced polymer), or any combination thereof. The body connector 320 is not limited to any specific geometry, axis, or actuation method, but is intended to encompass all suitable structures that enable rotational or angular displacement between components, whether through direct mechanical engagement, flexible materials, or other means.

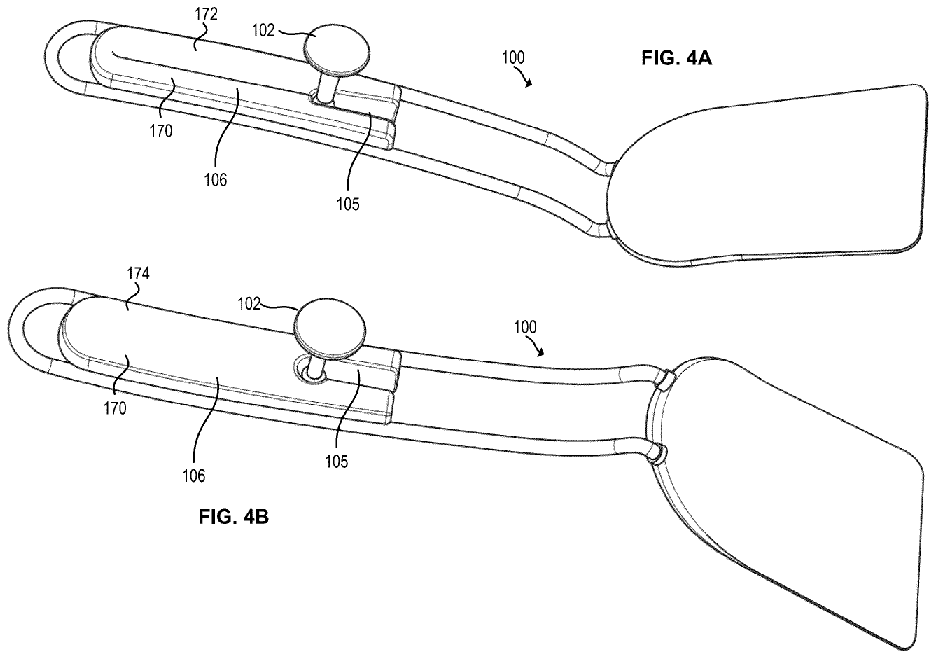

FIGS. 4A-B illustrates how, in the deployed configuration, the gripping member 102 may be pivoted and/or otherwise moved such that the gripping member 102 extends outwards and/or away from a first side 172 of a gripping surface 170 or a second side 174 of the gripping surface. Thus, FIGS. 4A-B demonstrate 180 degree swing of the gripping member 102 from either side.

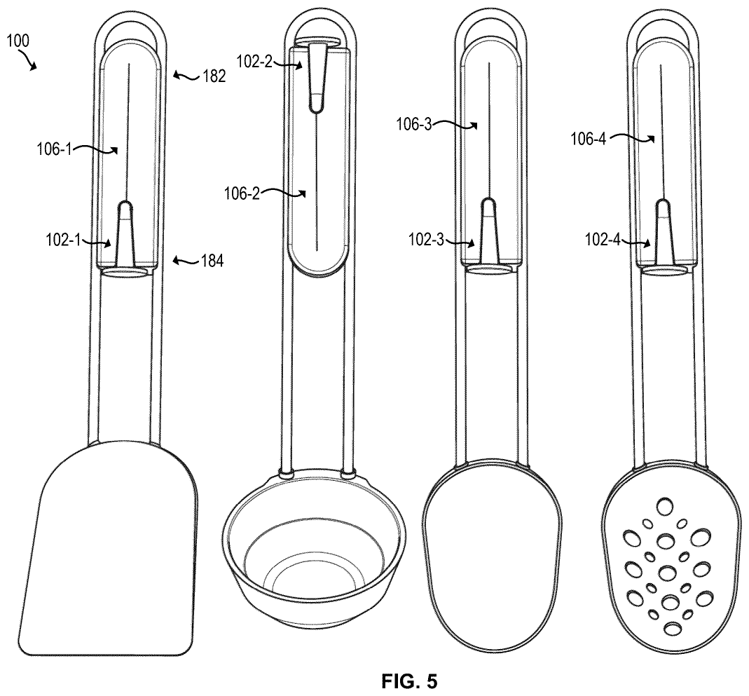

As previously mentioned, the movable gripping member 102 may be connected to various portions of a cooking tool 100 as desired. As non-limiting examples, and as illustrated in FIG. 5, the gripping members 108 may be located at a first end 182 of the handle 106, a second end 184 of the handle 106, or at a position in between. For example, handle 106-1 has the gripping member 102-1 at the second end 184 while handle 106-2 has the gripping member located at the first end 182.

FIGS. 6A-B illustrate the cooking tool 100 with a different work device 108 compared to FIGS. 1A-B. In particular, compared to the spatula as the work device 108 in FIGS. 1A-B, in FIGS. 6A-B, the work device 108 is a ladle. In addition, compared to the location of the gripping device 102 in FIGS. 1A-B, in FIGS. 6A-B, the gripping member 102 is connected to an end of the handle 106 opposite from the work device 108.

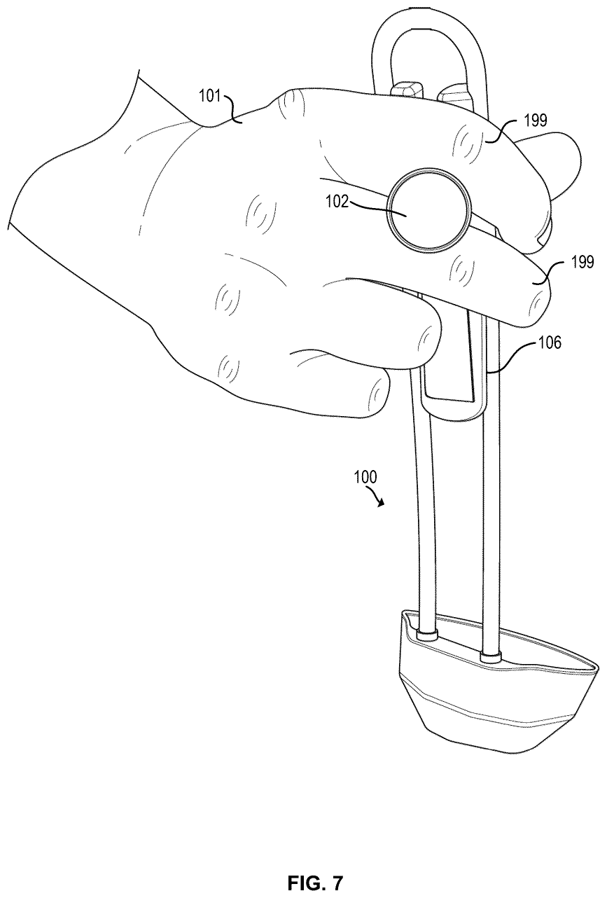

FIG. 7 is a non-limiting example illustrating how a user 101 may utilize the gripping member 102 to facilitate engagement with the cooking tool 100. In the example, the user 101 optionally may grip the handle 106 and slot the gripping member 7102 between a digit 199 for a secure grip that aids in manipulation of the cooking tool 100. Other techniques for engaging the cooking tool 100 and/or the gripping member 102 may be utilized as desired.

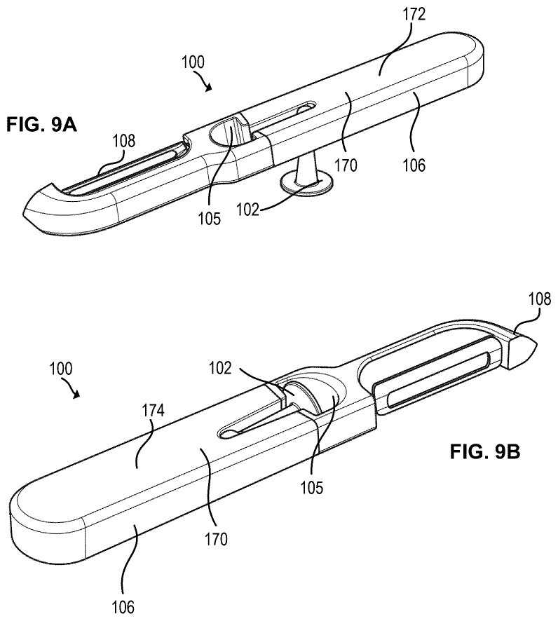

FIGS. 8A-B and 9A-B illustrate the cooking tool 100 with a different work device 108 compared to FIGS. 1A-B. In particular, compared to the spatula as the work device 108 in FIGS. 1A-B, in FIGS. 8A-B, the work device 108 is a peeler. The gripping member 102 may extend from the gripping surface 170 in a direction away from the first side 172 (FIG. 8A) or the second side 174 (FIG. 8B) demonstrating 180 degree swing from either side. In other embodiments, the gripping member 102 may only swing in a direction from one side and/or may be movable to extend away from one side. As illustrated in FIG. 9A, when extended, the gripping member 102 may support the cooking tool 100 on a surface such that the work device 108 and/or the handle 106 is supported off of the surface the cooking tool 100 is on. FIG. 9B illustrates the gripping member 102 stowed in the aperture 105 in an unobtrusive manner relative to the rest of the cooking tool 100.

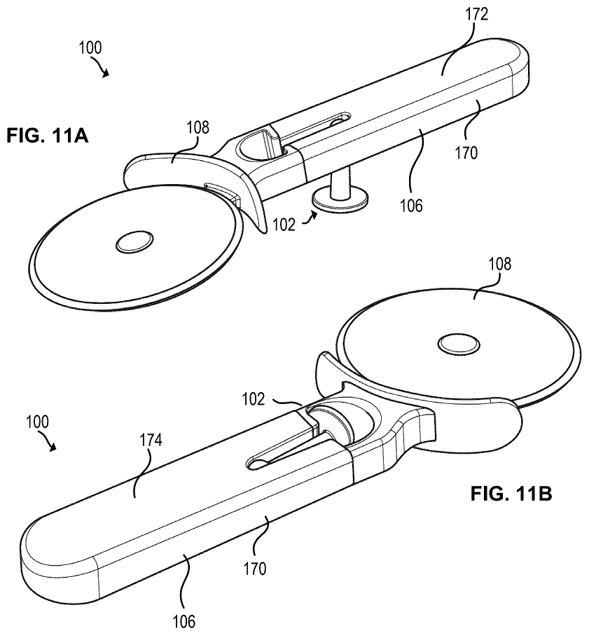

FIGS. 10A-B and 11A-B illustrate the cooking tool 100 with a different work device 108 compared to FIGS. 1A-B. In particular, compared to the spatula as the work device 108 in FIGS. 1A-B, in FIGS. 8A-B, the work device 108 is a pizza cutter. The gripping member 102 may extend from the gripping surface 170 in a direction away from the first side 172 (FIG. 10A) or the second side 174 (FIG. 10B) demonstrating 180 degree swing from either side. In other embodiments, the gripping member 102 may only swing in a direction from one side and/or may be movable to extend away from one side. As illustrated in FIG. 11A, when extended, the gripping member 102 may support the cooking tool 100 on a surface such that the work device 108 and/or the handle 106 is supported off of the surface the cooking tool 100 is on. FIG. 11B illustrates the gripping member 102 stowed in the aperture 105 in an unobtrusive manner relative to the rest of the cooking tool 100.

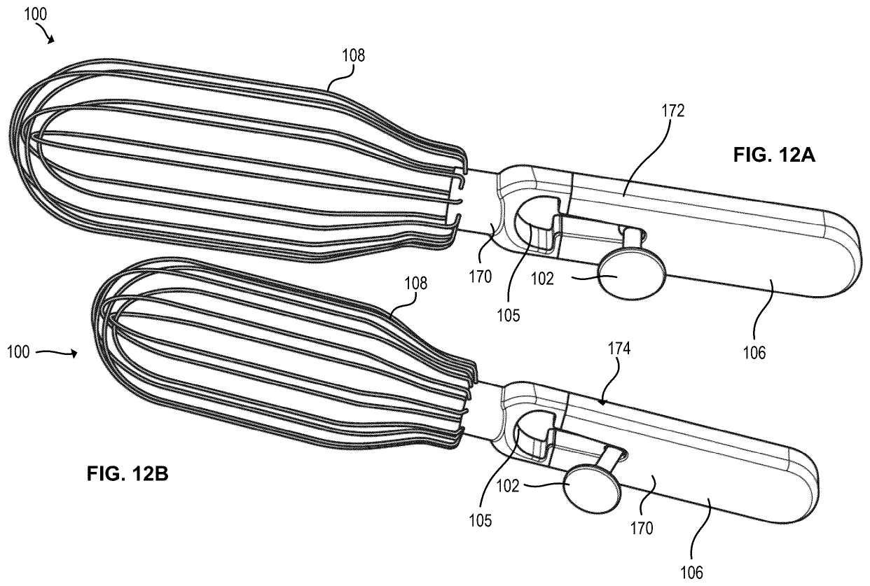

FIGS. 12A-B and 13A-B illustrate the cooking tool 100 with a different work device 108 compared to FIGS. 1A-B. In particular, compared to the spatula as the work device 108 in FIGS. 1A-B, in FIGS. 12A-B, the work device 108 is a whisk. The gripping member 102 may extend from the gripping surface 170 in a direction away from the first side 172 (FIG. 12A) or the second side 174 (FIG. 12B) demonstrating optional 180 degree swing from either side. In other embodiments, the gripping member 102 may only swing in a direction from one side and/or may be movable to extend away from one side. As illustrated in FIG. 13A, when extended, the gripping member 102 may support the cooking tool 100 on a surface such that the work device 108 and/or the handle 106 is supported off of the surface the cooking tool 100 is on. FIG. 13B illustrates the gripping member 102 stowed in the aperture 105 in an unobtrusive manner relative to the rest of the cooking tool 100.

FIGS. 14A-B and 15A-B illustrate the cooking tool 100 with a different work device 108 compared to FIGS. 1A-B. In particular, compared to the spatula as the work device 108 in FIGS. 1A-B, in FIGS. 14A-B, the work device 108 is a scoop. The gripping member 102 may extend from the gripping surface 170 in a direction away from the first side 172 (FIG. 14A) or the second side 174 (FIG. 14B) demonstrating optional 180 degree swing from either side. In other embodiments, the gripping member 102 may only swing in a direction from one side and/or may be movable to extend away from one side. As illustrated in FIG. 15A, when extended, the gripping member 102 may support the cooking tool 100 on a surface such that the work device 108 and/or the handle 106 is supported off of the surface the cooking tool 100 is on. FIG. 15B illustrates the gripping member 102 stowed in the aperture 105 in an unobtrusive manner relative to the rest of the cooking tool 100.

FIGS. 16A-B illustrate the cooking tool 100 with a different work device 108 compared to FIGS. 1A-B. In particular, compared to the spatula as the work device 108 in FIGS. 1A-B, in FIGS. 16A-B, the work device 108 is a can opener. The gripping member 102 may extend from the gripping surface 170 in a direction away from the first side 172 or the second side 174 and may be stowed (as depicted in FIG. 16A) within the aperture 105 of the handle 106. When extended, the gripping member 102 may support the cooking tool 100 on a surface such that the work device 108 and/or the handle 106 is supported off of the surface the cooking tool 100 is on.

While in some embodiments the cooking tool 100 may include the movable gripping member 102, in other embodiments, and as illustrated in FIGS. 17-22, the gripping member 102 may be fixed or non-movable. In these examples, the gripping member 102 may be a loop 109 which extends away from handle 106. The loop 109 may be integrally formed with the handle 106, connected to the handle 106, and/or otherwise attached and/or integrated into the handle 106. In certain embodiments, the gripping member 102 is aligned and/or overlaps the aperture 105, and the gripping member 102 extends away from the portion of the handle 106 with the aperture 105. In various embodiments, the gripping member 102 may define a second aperture 113 such that an apex of the loop extends away from the aperture 105. In certain embodiments, and as best illustrated in FIG. 17, the apex of the loop 109 may be at a height or elevation approximately equal to a bottom end of the work device 108 (e.g., the lower end of the measuring cup in FIG. 17). In such embodiments, the loop 109 of the gripping member 102 may be used to at least partially support the cooking tool 100 when the cooking tool 100 is on a surface, thereby providing improved stability to the cooking tool 100. Optionally, the loop 109 at such a height may further promote nesting with other cooking tools 100 as described in detail below.

The loop 109 may be formed as an annular, oval, polygonal, or otherwise closed or partially open structure that extends away from either the first side or the second side of the handle 106. The loop 109 may be dimensioned and oriented to permit comfortable engagement by one or more fingers, and may provide leverage, ergonomic control, or support during use. The loop 109 may be constructed from any material suitable for culinary environments and repeated handling, including, without limitation, a metal (e.g., stainless steel, aluminum), an alloy (e.g., anodized aluminum alloy), a plastic (e.g., food-grade polypropylene, polycarbonate), a ceramic (e.g., glazed stoneware, porcelain), a polymer (e.g., silicone, thermoplastic elastomer), or any combination thereof. The material may be selected for properties such as heat resistance, ease of cleaning, durability, and non-reactivity with foodstuffs, and may further include surface treatments such as texturing, non-slip coatings, antimicrobial finishes, or thermal insulation to enhance comfort and safety.

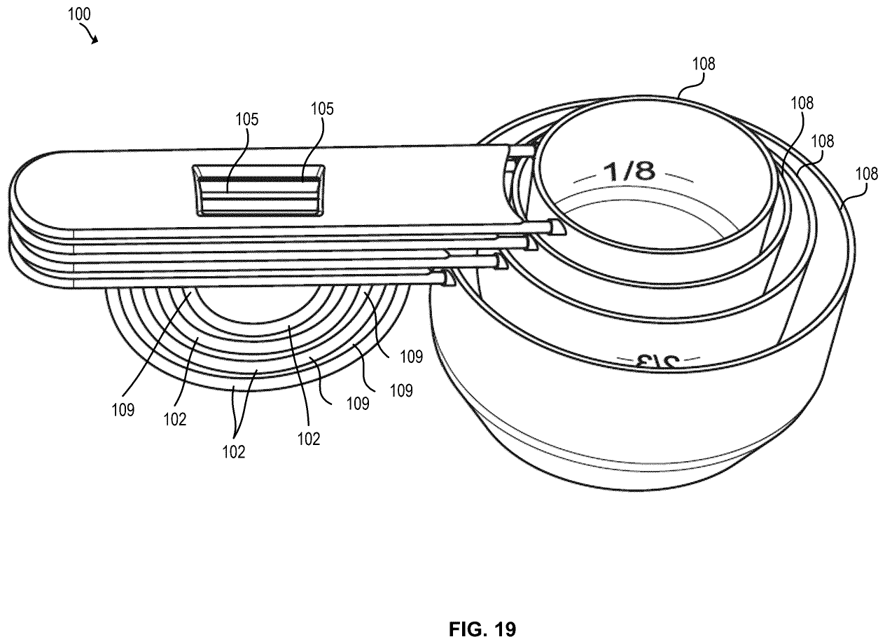

FIGS. 17-19 illustrates the cooking tool 100 with the fixed gripping member 102 and where the work devices 108 are in the form of measuring cups. As best illustrated in FIG. 19, in embodiments with a plurality of cooking tools 100 (e.g., measuring cups, measuring spoons, etc.), the apertures 105 and gripping portions 102 may be in complimentary positions to facilitate nesting of a plurality of cooking tools 100. By way of example, and as illustrated in FIGS. 17-19, the cooking tools 100 may be appropriately sized to receive subsequent cooking tools of diminishing sizes within the work devices 108. Similarly, the gripping portions 102 and/or loops 109 and apertures 105 may have diminishing sizes, with the gripping portion 102 of one cooking tool 100 insertable at least partially into the aperture 105 of another cooking tool. As a non-limiting example, each of the cooking tools 100 in FIGS. 17-19 may each have a different volumetric capacity such that each successive cooking tool 100 is smaller than the preceding cup to allow the cooking tools 100 to be nested or stacked within one another. In certain embodiments, the work devices 108 and/or gripping members 102 may lock or secure into one another when nested, providing a compact, organized, and stable arrangement for storage and transport.

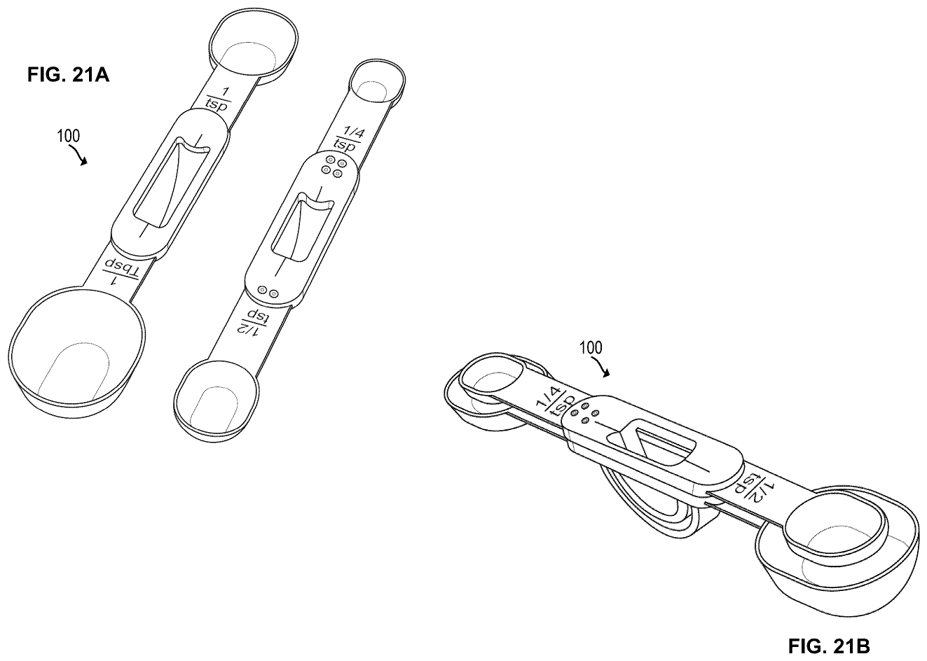

FIGS. 20A-C and 21A-B illustrate additional examples of cooking tools 100 with fixed gripping members 102. Compared to FIGS. 17-19, the work device in FIGS. 20A-C includes measuring spoons, and the cooking tools 100 further include two work devices 108 at opposing ends. In some embodiments, each work device 108 may be different on each side of the cooking tool 100, although it need not be different in other embodiments. In some embodiments, the work devices 108 are a similar type of work device (e.g., measuring spoon) with a same or different volume or size. Optionally, each work device 108 structurally may be mirror images with the exception of the different work devices 108. The gripping members 102 may slot and/or nest into one another in a stacked configuration. FIG. 21A illustrates the cooking tools 100 in an un-nested configuration, and FIG. 21B illustrates the cooking tools 100 in a stacked or nested configuration.

FIG. 22 illustrates another cooking tool 100 with a fixed gripping member 102. In FIG. 22, the work device 108 includes a first tong 115 and a second tong 117, which are connected via the frame 104 and configured to grasp, hold, or manipulate foodstuffs. In certain embodiments, the first tong 115 and a second tong 117 are provided with the gripping member 102, which may be integrally formed with or attached to the handle 106 or the frame 104. The gripping member 102 may be configured to facilitate comfortable and secure engagement by the user, such as by insertion of one or more digits (e.g., fingers), grasping, or wrapping to improve control, leverage, and/or ergonomic comfort during use.

In some embodiments, the frame 104 may further be provided with a locking mechanism 117 (such as but not limited to a locking lever) that is operable to selectively secure the position or angle of the first tong 115 relative to the second tong 117 at one or more predetermined angles to enable the tongs to be maintained in a plurality of stable configurations suitable for various culinary tasks. As a non-limiting example, the locking mechanism 117 is movable between at least three positions, the at least three positions including a first position in which the tongs 115, 117 are closed and/or relative movement between the arms is prevented, a second position in which the tongs 115, 117 are movable in a first range of movement, and a third position in which tongs 115, 117 arms are movable in a second range of movement greater than the first range of movement. In one non-limiting example, the first range of movement may be from 0-20 degrees, while the second range of movement may be from 0-40 degrees. Other ranges of movement may be utilized for the first range or the second range as desired.

In certain embodiments, the locking mechanism 117 is movable between the at least three positions by movement in the side-to-side direction 119. Optionally, the side-to-side direction is a direction perpendicular to an axis of at least one tong 115, 117.

A collection of exemplary embodiments are provided below, including at least some explicitly enumerated as “Illustrations” providing additional description of a variety of example embodiments in accordance with the concepts described herein. These illustrations are not meant to be mutually exclusive, exhaustive, or restrictive; and the disclosure not limited to these example illustrations but rather encompasses all possible modifications and variations within the scope of the issued claims and their equivalents.
Illustration 1: A cooking tool for handing foodstuff objects comprising a handle, the handle comprising a gripping surface having a first side and a second side and a gripping member configured to extend from the gripping surface in a direction away from the first side or the second side, wherein the gripping member is configured to interface with at least one digit of a hand of a user or a support surface, and wherein the gripping surface includes a first aperture defined at least in part by a structure of the gripping member. The cooking tool further includes a first work device configured to interact with a foodstuff object, and a frame that extends within at least a portion of the handle and is coupled to at least a portion of the first work device.
Illustration 2. The cooking tool of any preceding or subsequent illustration or combination of illustrations, wherein the gripping member comprises a body connector configured to pivot the gripping member about the handle, a surface, and a body extending between the body connector and the surface.
Illustration 3. The cooking tool of any preceding or subsequent illustration or combination of illustrations, wherein actuation of the body causes the body connector to pivot the body between a first position, a second position, and a third position.
Illustration 4. The cooking tool of any preceding or subsequent illustration or combination of illustrations, wherein in the first position, the body extends outward from the first side of the handle, in the second position, the body is seated at least partially within and parallel to the first aperture such that a majority of the body is seated within the first aperture, and in the third position, the body extends outward from the second side of the handle.
Illustration 5. The cooking tool of any preceding or subsequent illustration or combination of illustrations, wherein the surface is textured.
Illustration 6. The cooking tool of any preceding or subsequent illustration or combination of illustrations, wherein the surface includes a concave surface, a planar surface, a convex surface, or a combination thereof.
Illustration 7. The cooking tool of any preceding or subsequent illustration or combination of illustrations, wherein the surface includes at least one linearly angled surface.
Illustration 8. The cooking tool of any preceding or subsequent illustration or combination of illustrations, wherein the body connector is made of a material selected from the group consisting of a metal, an alloy, a plastic, a ceramic, a polymer, or a combination thereof.
Illustration 9. The cooking tool of any preceding or subsequent illustration or combination of illustrations, wherein the surface is made of a material selected from the group consisting of a metal, an alloy, a plastic, a ceramic, a polymer, or a combination thereof.
Illustration 10. The cooking tool of any preceding or subsequent illustration or combination of illustrations, wherein the surface and the body have a unitary structure.
Illustration 11. The cooking tool of any preceding or subsequent illustration or combination of illustrations, wherein the body connector is a ball seated within the first aperture.
Illustration 12. The cooking tool of any preceding or subsequent illustration or combination of illustrations, wherein the handle comprises a cover.
Illustration 13. The cooking tool of any preceding or subsequent illustration or combination of illustrations, wherein the frame is made of a material selected from the group consisting of a metal, an alloy, a plastic, a ceramic, a polymer, or a combination thereof.
Illustration 14. The cooking tool of any preceding or subsequent illustration or combination of illustrations, wherein the gripping member is a loop, and the loop extends away from the first side or the second side of the handle.
Illustration 15. The cooking tool of any preceding or subsequent illustration or combination of illustrations, wherein the loop includes a second aperture where the first aperture is perpendicular to the second aperture such that an apex of the loop extends away from the first aperture.
Illustration 16. The cooking tool of any preceding or subsequent illustration or combination of illustrations, wherein the loop is made of a material selected from the group consisting of a metal, an alloy, a plastic, a ceramic, a polymer, or a combination thereof.
Illustration 17. The cooking tool of any preceding or subsequent illustration or combination of illustrations, wherein the frame is connected to a second work device opposite of the first work device, and the loop is between the first work device and the second work device.
Illustration 18. The cooking tool of any preceding or subsequent illustration or combination of illustrations, wherein the work device comprises a first tong and a second tong, the frame is configured to selectively lock the position of the first tong relative to the second tong in a first configuration, a second configuration, and a third configuration, and in the first configuration, the first tong and the second tong are separated by a first distance, in the second configuration, the first tong and the second tong are separated by a second distance larger than the first distance, and in the third configuration, the second tong and the first tong are separated by a third distance larger than the second distance.
Illustration 19. The cooking tool of any preceding or subsequent illustration or combination of illustrations, wherein the work device is selected from the group consisting of: a spatula, a pizza cutter, a can opener, tongs, a measuring cup, a measuring spoon, a whisk, a ladle, a slotted spoon, a serving spoon, a fork, a knife, a peeler, a grater, a zester, a bottle opener, a garlic press, a potato masher, a strainer, a sieve, a pastry brush, a scoop, a melon baller, a meat tenderizer, a juicer, a pestle, a thermometer, a cheese slicer, a butter curler, an egg separator, an apple corer, a cherry pitter, a nutcracker, a fish scaler, a bread knife, a pizza peel, a cake server, a pie server, a cookie cutter, a pasta fork, a spaghetti server, a turner, a rice paddle, a dough hook, shears, a crinkle cutter, or combinations thereof.
Illustration 20. A cooking tool for handing foodstuff objects comprising a handle, the handle comprising a gripping surface having a first side and a second side and a loop configured to extend from the gripping surface in a direction away from either the first side or the second side. The loop is configured to interface with at least one digit of a hand of a user or a support surface, and the gripping surface includes a first aperture defined at least in part by a structure of the loop. The device further includes a first work device configured to cause a force in a first direction to be pressed on a foodstuff object, and a second work device configured to cause a second force in a second direction to be pressed on the foodstuff object. A frame extends within at least a portion of the handle and is coupled to at least a portion of both the first work device and the second work device.
Illustration 22. A cooking tool comprising: a work device; a handle; and a handle; and a gripping post pivotably coupled to the handle, wherein the gripping post comprises a post body and flange end opposite from an end of the gripping post coupled to handle.
Illustration 23. The cooking tool of any preceding or subsequent illustration of combination of illustrations, wherein the gripping post is pivotable between a stowed position in which the gripping post is at least partially within the handle and a deployed position in which flange end of post is spaced apart from handle.
Illustration 24. The cooking tool of any preceding or subsequent illustration of combination of illustrations, wherein the post and flange end are different material.
Illustration 25. The cooking tool of any preceding or subsequent illustration of combination of illustrations, wherein the gripping post also moves side to side when not stowed.
Illustration 26. The cooking tool of any preceding or subsequent illustration of combination of illustrations, wherein the handle has first portion defining an end of the cooking tool opposite from the work device and second portion between end and cooking feature.
Illustration 27. The cooking tool of any preceding or subsequent illustration of combination of illustrations, wherein the gripping post is pivotably coupled to second portion.
Illustration 28. The cooking tool of any preceding or subsequent illustration of combination of illustrations, wherein the gripping post is pivotably coupled to the first portion.
Illustration 29. The cooking tool of any preceding or subsequent illustration of combination of illustrations, wherein the handle defines an aperture configured to receive gripping post in stowed position
Illustration 30. A cooking tool comprising: a work device; a handle with an upper surface and a lower surface; and a loop projecting outwards from the lower surface.
Illustration 31. The cooking tool of any preceding or subsequent illustration of combination of illustrations, wherein the work device is a first work device, and the cooking tool comprises a second work device, wherein the first and second work devices are on opposing ends of the handle.
Illustration 32. The cooking tool of any preceding or subsequent illustration of combination of illustrations, wherein an aperture defined in handle corresponds to a location of the loop.
Illustration 33. The cooking tool of any preceding or subsequent illustration of combination of illustrations, wherein the aperture in the handle is configured to receive a loop of another cooking tool such that the loop is nested within the aperture.
Illustration 34. The cooking tool of any preceding or subsequent illustration of combination of illustrations, wherein the work device is a cup, and wherein a bottom or apex of the loop aligns with the bottom of cup
Illustration 35. The cooking tool of any preceding or subsequent illustration of combination of illustrations, wherein the cooking tool is tongs, and wherein the tongs further include a locking lever.
Illustration 36. Cooking tongs comprising: a pair of arms pivotably connected in a first direction; a locking lever for controlling positioning/an angle between the arms, wherein the locking lever is movable in side to side direction between three positions.
Illustration 37. The cooking tongs of any preceding or subsequent illustration of combination of illustrations, wherein, in the first position, the arms of the tongs are closed and/or the arms are prevented from relative movement, in the second position, the arms of the tongs have a first range of movement, and in the third position, the arms have a second range of movement.
Illustration 38. The cooking tongs of any preceding or subsequent illustration of combination of illustrations, wherein the first range of movement is 0-20 degrees, and wherein the second range of movement is 0-40 degrees.
Illustration 39. The cooking tongs of any preceding or subsequent illustration of combination of illustrations, wherein the second range of movement is greater than the first range of movement.
Illustration 40. A cooking tool for handing foodstuff objects, the cooking tool comprising: a work device configured to interact with a foodstuff object; a handle comprising a first side and a second side opposite the first side; and a gripping member configured to extend outwards from the handle in a direction away from the first side or the second side.
Illustration 41. The cooking tool of any preceding or subsequent illustration of combination of illustrations, further comprising a frame that extends within at least a portion of the handle and is coupled to at least a portion of the work device.
Illustration 42. The cooking tool of any preceding or subsequent illustration of combination of illustrations, wherein the gripping member is movable relative to the handle between a stowed configuration and a deployed configuration, wherein, in the deployed configuration, the gripping member extends from the handle in the direction away from the first side or the second side.
Illustration 43. The cooking tool of any preceding or subsequent illustration of combination of illustrations, wherein, in the stowed configuration, the gripping member is positioned within an aperture defined by the handle.
Illustration 44. The cooking tool of any preceding or subsequent illustration of combination of illustrations, wherein the gripping member is pivotable relative to the handle.
Illustration 45. The cooking tool of any preceding or subsequent illustration of combination of illustrations, wherein gripping member comprises a first end and a second end, wherein the first end is connected to the handle, and wherein the second end is a free end.
Illustration 46. The cooking tool of any preceding or subsequent illustration of combination of illustrations, wherein gripping member comprises a head end and a flange end, wherein a width of the flange end is greater than a width of the head end, and wherein the head end is connected to the handle.
Illustration 47. The cooking tool of any preceding or subsequent illustration of combination of illustrations, wherein the handle comprises a first end adjacent to the work device and a second end opposite from the first end, and wherein the gripping member is pivotably connected to the first end.
Illustration 48. The cooking tool of any preceding or subsequent illustration of combination of illustrations, wherein the handle comprises a first end adjacent to the work device and a second end opposite from the first end, and wherein the gripping member is pivotably connected to the second end.
Illustration 49. The cooking tool of any preceding or subsequent illustration of combination of illustrations, wherein the handle defines an aperture, and wherein the aperture of the handle is aligned with the gripping member.
Illustration 50. The cooking tool of any preceding or subsequent illustration of combination of illustrations, wherein the work device is a first work device connected to the handle, and wherein the cooking tool comprises a second device connected to the handle opposite from the first work device.
Illustration 51. The cooking tool of any preceding or subsequent illustration of combination of illustrations, wherein the gripping member is fixed relative to the handle.
Illustration 52. The device of any preceding or subsequent illustration of combination of illustrations, wherein gripping member is a loop extending outwards from the first side or the second side of the handle.
Illustration 53. The device of any preceding or subsequent illustration of combination of illustrations, wherein the handle defines a first aperture aligned with the loop, and wherein the loop defines a second aperture, wherein the first aperture is open in a first direction, and the second aperture is open in a second direction.
Illustration 54. The device of any preceding or subsequent illustration of combination of illustrations, wherein an apex of the loop extends away from the first aperture.
Illustration 55. The device of any preceding or subsequent illustration of combination of illustrations, wherein the loop comprises a first material and the handle comprises a second material different from the first material.
Illustration 56. The device of any preceding or subsequent illustration of combination of illustrations, wherein an apex of the loop is aligned with a bottom end of the work device.
Illustration 57. The device of any preceding or subsequent illustration of combination of illustrations, wherein the work device is a first work device connected to the handle, and wherein the cooking tool comprises a second device connected to the handle opposite from the first work device, and wherein the loop is between the first work device and the second work device.
Illustration 58. The device of any preceding or subsequent illustration of combination of illustrations, wherein the work device comprises a first tong and a second tong, wherein the cooking device further comprises a locking lever configured to selectively lock a position the first tong relative to the second tong in a first configuration, a second configuration, and a third configuration by moving the locking lever in a side-to-side direction, and wherein in the first configuration, the first tong and the second tong locked, in the second configuration, the first tong and the second tong have a first range of movement, and in the third configuration, the second tong and the first tong have a second range of movement greater than the first range of movement.

It will be appreciated by those skilled in the art that the various components, features, elements, and embodiments described throughout this disclosure may be combined, substituted, interchanged, or otherwise incorporated together in any suitable manner, unless expressly stated otherwise or structurally incompatible. Any reference to a particular configuration, material, method, or embodiment is intended to be illustrative and non-limiting, and it is contemplated that any one or more features disclosed herein may be selectively included, omitted, or modified in accordance with the needs or preferences of a given application or manufacturing process. Furthermore, unless specifically indicated, all embodiments, aspects, and alternatives described are mutually compatible and may be implemented in combination with one another, regardless of the order or context in which they are presented.

The use of singular or plural terminology and the recitation of specific examples or preferred embodiments is not intended to limit the scope of the disclosure, and all equivalents, modifications, and variations are within the spirit and scope of the inventive concepts disclosed herein.

As used herein, the terms “disclosure,” “the disclosure,” “this disclosure” and “the present disclosure” are intended to refer broadly to all of the subject matter of this patent application and the claims below. Statements containing these terms should be understood not to limit the subject matter described herein or to limit the meaning or scope of the claims below.

As used herein, the meaning of “a,” “an,” or “the” includes singular and plural references unless the context clearly dictates otherwise.

All ranges disclosed herein are to be understood to encompass any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more, e.g. 1 to 6.1, and ending with a maximum value of 10 or less, e.g., 5.5 to 10.

The above-described aspects are merely possible examples of implementations, merely set forth for a clear understanding of the principles of the present disclosure. Many variations and modifications may be made to the above-described embodiment(s) without departing substantially from the spirit and principles of the present disclosure. All such modifications and variations are intended to be included herein within the scope of the present disclosure, and all possible claims to individual aspects or combinations of elements or steps are intended to be supported by the present disclosure. Moreover, although specific terms are employed herein, as well as in the claims that follow, they are used only in a generic and descriptive sense, and not for the purposes of limiting the described embodiments, nor the claims that follow.

What is claimed is:

1. A cooking tool for handing foodstuff objects, the cooking tool comprising:
a work device configured to interact with a foodstuff object;
a handle comprising a first side and a second side opposite the first side; and
a gripping member configured to extend outwards from the handle in a direction away from the first side or the second side.

2. The cooking tool of claim 1, further comprising a frame that extends within at least a portion of the handle and is coupled to at least a portion of the work device.

3. The cooking tool of claim 1, wherein the gripping member is movable relative to the handle between a stowed configuration and a deployed configuration, wherein, in the deployed configuration, the gripping member extends from the handle in the direction away from the first side or the second side.

4. The cooking tool of claim 3, wherein, in the stowed configuration, the gripping member is positioned within an aperture defined by the handle.

5. The cooking tool of claim 3, wherein the gripping member is pivotable relative to the handle.

6. The cooking tool of claim 3, wherein gripping member comprises a first end and a second end, wherein the first end is connected to the handle, and wherein the second end is a free end.

7. The cooking tool of claim 3, wherein gripping member comprises a head end and a flange end, wherein a width of the flange end is greater than a width of the head end, and wherein the head end is connected to the handle.

8. The cooking tool of claim 3, wherein the handle comprises a first end adjacent to the work device and a second end opposite from the first end, and wherein the gripping member is pivotably connected to the first end.

9. The cooking tool of claim 3, wherein the handle comprises a first end adjacent to the work device and a second end opposite from the first end, and wherein the gripping member is pivotably connected to the second end.

10. The cooking tool of claim 1, wherein the handle defines an aperture, and wherein the aperture of the handle is aligned with the gripping member.

11. The cooking tool of claim 1, wherein the work device is selected from the group consisting of: a spatula, a pizza cutter, a can opener, tongs, a measuring cup, a measuring spoon, a whisk, a ladle, a slotted spoon, a serving spoon, a fork, a knife, a peeler, a grater, a zester, a bottle opener, a garlic press, a potato masher, a strainer, a sieve, a pastry brush, a scoop, a melon baller, a meat tenderizer, a juicer, a pestle, a thermometer, a cheese slicer, a butter curler, an egg separator, an apple corer, a cherry pitter, a nutcracker, a fish scaler, a bread knife, a pizza peel, a cake server, a pie server, a cookie cutter, a pasta fork, a spaghetti server, a turner, a rice paddle, a dough hook, shears, a crinkle cutter, or combinations thereof.

12. The cooking tool of claim 1, wherein the work device is a first work device connected to the handle, and wherein the cooking tool comprises a second device connected to the handle opposite from the first work device.

13. The cooking tool of claim 1, wherein the gripping member is fixed relative to the handle.

14. The device of claim 13, wherein gripping member is a loop extending outwards from the first side or the second side of the handle.

15. The device of claim 14, wherein the handle defines a first aperture aligned with the loop, and wherein the loop defines a second aperture, wherein the first aperture is open in a first direction, and the second aperture is open in a second direction.

16. The device of claim 15, wherein an apex of the loop extends away from the first aperture.

17. The device of claim 14, wherein the loop comprises a first material and the handle comprises a second material different from the first material.

18. The device of claim 14, wherein an apex of the loop is aligned with a bottom end of the work device.

19. The device of claim 14, wherein the work device is a first work device connected to the handle, and wherein the cooking tool comprises a second device connected to the handle opposite from the first work device, and wherein the loop is between the first work device and the second work device.

20. The device of claim 14, wherein the work device comprises a first tong and a second tong, wherein the cooking device further comprises a locking lever configured to selectively lock a position the first tong relative to the second tong in a first configuration, a second configuration, and a third configuration by moving the locking lever in a side-to-side direction, and wherein
in the first configuration, the first tong and the second tong locked,
in the second configuration, the first tong and the second tong have a first range of movement, and
in the third configuration, the second tong and the first tong have a second range of movement greater than the first range of movement.
